(19) United States
(12) Patent Application Publication
(10) Pub. No.: US 2026/0279884 A1
(43) Pub. Date: Sep. 17, 2026

(54) Alignment Stage and Secondary Battery Manufacturing Apparatus Including the Same

(71) Applicant: SK On Co., Ltd., Seoul (KR)

(72) Inventors: Jong Mo PARK, Daejeon (KR); Se June KIM, Daejeon (KR); Tae Hyun KIM, Daejeon (KR); Soo Yeon PARK, Daejeon (KR); Ji Won YANG, Daejeon (KR); Sung Hwan CHO, Daejeon (KR)

(21) Appl. No.: 19/563,014

(22) Filed: Mar. 11, 2026

(30) Foreign Application Priority Data
Mar. 13, 2025 (KR) 10-2025-0032462
Jul. 2, 2025 (KR) 10-2025-0088282

(51) Int. Cl. H01M 10/04

(52) U.S. Cl. CPC H01M 10/0486; H01M 10/0413

(57) ABSTRACT

Disclosed are an alignment stage and a secondary battery manufacturing apparatus including the same. The alignment stage includes a first plate at least partially made of a first material having light transmittance and a second plate at least partially made of a second material having light transmittance, the second plate being disposed on one surface of the first plate, the second plate being provided with a suction surface configured to allow an electrode sheet to be adhered thereto by suction, wherein the second material has higher hardness than the first material.

### CROSS-REFERENCE TO RELATED APPLICATION

This application claims the benefit of priority to Korean Patent Application Nos. 10-2025-0032462 filed on Mar. 13, 2025, and 10-2025-0088282 filed on Jul. 2, 2025, the disclosure of which is incorporated herein by reference in its entirety.

### TECHNICAL FIELD

Embodiments of the present disclosure relate to an alignment stage and a secondary battery manufacturing apparatus including the same.

### BACKGROUND

A secondary battery is an energy storage means capable of being charged and discharged through electrochemical reaction. Secondary batteries are used in various fields using electrical energy. For example, secondary batteries are widely used in mobile devices such as mobile phones, laptop computers, and tablet computers, and broader utilization thereof is being pursued in transportation equipment such as vehicles, aircraft, and ships. In addition, demand for secondary batteries is increasing in the energy storage system (ESS) field for utilizing surplus power.

Some secondary batteries may be configured such that first and second electrode sheets are alternately and repeatedly stacked. More specifically, each of the first and second electrode sheets may be provided as a single rectangular sheet, and the first and second electrode sheets each provided as a single sheet may be alternately and repeatedly stacked with separators interposed therebetween. In stacking of the electrode sheets, each electrode sheet needs to be appropriately aligned prior to stacking.

### SUMMARY

Some embodiments of the present disclosure may provide an alignment stage and a secondary battery manufacturing apparatus including the same.

In addition, some embodiments of the present disclosure may provide an alignment stage capable of appropriately aligning an electrode sheet and a secondary battery manufacturing apparatus including the same.

In addition, some embodiments of the present disclosure may provide an alignment stage capable of appropriately capturing an image of the position of an electrode sheet through a camera and a secondary battery manufacturing apparatus including the same.

In addition, some embodiments of the present disclosure may provide an alignment stage capable of more clearly determining the position of an electrode sheet and a secondary battery manufacturing apparatus including the same.

In addition, some embodiments of the present disclosure may provide an alignment stage with improved durability and a secondary battery manufacturing apparatus including the same.

Some embodiments of the present disclosure may be widely adopted in green technology fields such as electric vehicles, battery charging stations, and other battery-utilizing applications like solar power generation and wind power generation. In addition, some embodiments of the present disclosure may be used in eco-friendly electric vehicles (EVs) and hybrid vehicles (HVs) to prevent climate change by suppressing air pollution and greenhouse gas emissions.

According to an aspect of the present disclosure, an alignment stage includes a first plate at least partially made of a first material having light transmittance and a second plate at least partially made of a second material having light transmittance, the second plate being disposed on one surface of the first plate, the second plate being provided with a suction surface configured to allow an electrode sheet to be adhered thereto by suction, wherein the second material has higher hardness than the first material.

In some embodiments, the first plate may be provided with a flow channel in which suction pressure for suctioning the electrode sheet is provided, and the flow channel may extend in the first plate from an at least one first opening disposed in an exposed surface of the first plate to an at least one second opening disposed in the one surface.

In some embodiments, the flow channel may be provided in the first plate such that the extension direction thereof is changed at least once.

In some embodiments, the second opening may be disposed so as to correspond to a through-hole provided in the first plate and may be configured to supply the suction pressure to the through-hole.

In some embodiments, the first plate may include a protrusion provided on the one surface, the protrusion being configured to cover at least a part of an edge of the second plate.

In some embodiments, the protrusion may extend so as to cover the entire edge.

In some embodiments, the protrusion may be configured to guide the coupling position of the second plate on the one surface.

In some embodiments, the first material may include acrylic or polycarbonate.

In some embodiments, the second plate may be provided with at least one through-hole, and the through-hole may be formed through the second plate in a thickness direction from the suction surface.

In some embodiments, the through-hole may be provided in plural so as to be disposed on the suction surface while being spaced apart from each other by a predetermined distance.

In some embodiments, the second material may include glass or soda-lime glass.

In some embodiments, the alignment stage may further include an adhesive layer provided between the first and second plates, the adhesive layer being configured to adhere the first and second plates to each other.

In some embodiments, the first plate may have at least one second opening disposed in the one surface thereof, and a sleeve configured to prevent the adhesive layer from flowing into the second opening may be provided at an edge of the second opening.

According to another aspect of the present disclosure, a secondary battery manufacturing apparatus includes an alignment stage configured to allow an electrode sheet to be disposed on one surface thereof, an illumination unit disposed on one side of the alignment stage corresponding to the one surface, the illumination unit being configured to illuminate the electrode sheet, and a camera disposed on the opposite side of the alignment stage so as to correspond to the illumination unit, the camera being configured to capture an image of the electrode sheet, wherein the alignment stage includes a first plate made of a first material having at least partial light transmittance and a second plate made of a second material having at least partial light transmittance, the second plate being disposed on one surface of the first plate, the second plate being provided with a suction surface configured to allow the electrode sheet to be adhered thereto by suction, and the second material has higher hardness than the first material.

In some embodiments, the secondary battery manufacturing apparatus may further include an alignment unit configured to correct the position of the alignment stage based on the alignment state of the electrode sheet identified through the camera.

### BRIEF DESCRIPTION OF THE DRAWINGS

FIG. 1 is an illustrative view showing an electrode sheet stacking process;

FIG. 2 is a plan view showing an alignment stage according to an embodiment of the present disclosure;

FIG. 3 is a perspective view of the alignment stage shown in FIG. 2;

FIG. 4 is an exploded perspective view of the alignment stage shown in FIG. 3;

FIG. 5 is a sectional view of a first plate shown in FIG. 4;

FIG. 6 is a sectional view of a second plate shown in FIG. 4;

FIG. 7 is an exploded perspective view showing an alignment stage according to another embodiment of the present disclosure;

FIG. 8 is a sectional view of the alignment stage shown in FIG. 7;

FIG. 9 is an exploded perspective view showing an alignment stage according to yet another embodiment of the present disclosure;

FIG. 10 is a sectional view of the alignment stage shown in FIG. 9;

FIG. 11 is an exploded perspective view showing an alignment stage according to a further embodiment of the present disclosure; and

FIG. 12 is a side view showing a secondary battery manufacturing apparatus according to an embodiment of the present disclosure.

### DETAILED DESCRIPTION

Hereinafter, the present disclosure will be described in detail with reference to the accompanying drawings. However, this is merely illustrative, and the present disclosure is not limited to specific embodiments described by way of example.

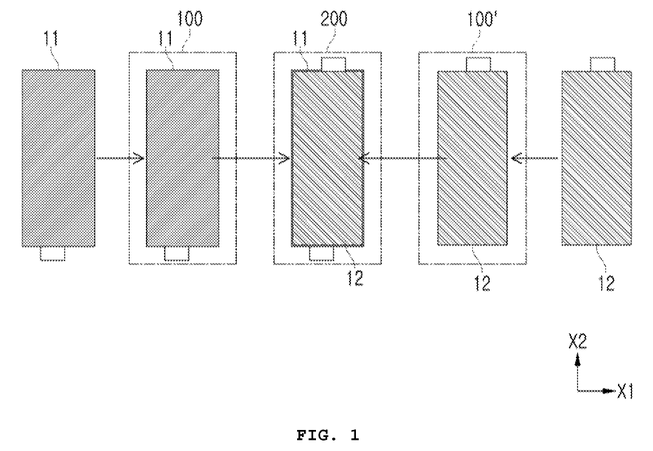

FIG. 1 is an illustrative view showing an electrode sheet stacking process.

Referring to FIG. 1, in some embodiments, a secondary battery may include an electrode assembly, wherein the electrode assembly may be configured such that first and second electrode sheets 11 and 12 are alternately and repeatedly stacked. For example, in the shown embodiment, each of the first and second electrode sheets 11 and 12 may be provided as a single rectangular sheet, and the first and second electrode sheets 11 and 12 each provided as a single sheet may be alternately and repeatedly stacked with separators interposed therebetween to form an electrode assembly. For reference, the separators are omitted from FIG. 1. Furthermore, the electrode assembly manufactured in this manner may be received in an outer casing together with an electrolyte, etc., to form a secondary battery. For example, the electrode assembly may be received in a flexible film-type outer casing to form a pouch-shaped battery cell, or received in an outer casing configured as a prismatic case to form a prismatic battery cell. However, in the present disclosure, the type, form, etc. of the secondary battery are not particularly limited.

In the above, each of the electrode sheets 11 and 12 may be appropriately aligned prior to stacking. More specifically, when describing the first electrode sheet 11 by way of example, the first electrode sheet 11 may be supplied to an alignment stage 100 through a feeder, etc., and the alignment state of the first electrode sheet 11 disposed on the alignment stage 100 may be identified through a camera. In addition, the position of the alignment stage 100 may be appropriately corrected based on the identified alignment state. For example, if the position of the first electrode sheet 11 identified through the camera deviates from a reference position, the alignment stage 100 may move and/or rotate by a distance compensating for the deviation on an X1-X2 plane to correct the position of the first electrode sheet 11. The first electrode sheet 11 may be supplied to and stacked on a stacking stage 200 through the feeder, etc., in the aligned state. Similarly, the second electrode sheet 12 may also be supplied to and stacked on the stacking stage 200 after being aligned through an alignment stage 100’.

In some embodiments, the alignment state of each of the electrode sheets 11 and 12 disposed on the alignment stage 100 may be identified through the camera. In some embodiments, the camera may be disposed on the side opposite to one surface of the alignment stage 100 on which the electrode sheets 11 and 12 are disposed. For example, in the shown embodiment, the electrode sheets 11 and 12 may be disposed on an upper surface of the alignment stage 100, and the camera may be disposed under the alignment stage 100. Such placement has the advantage of facilitating placement of a transfer apparatus (a pick and place machine; a P&P machine) configured to transfer each of the electrode sheets 11 and 12, etc. above the alignment stage 100. Furthermore, in this arrangement, the alignment stage 100 may be made of a material having at least partial light transmittance in order to capture an image of each of the electrode sheets 11 and 12 through the camera. As will be described later, some embodiments of the present disclosure may provide an alignment stage 100 having light transmittance.

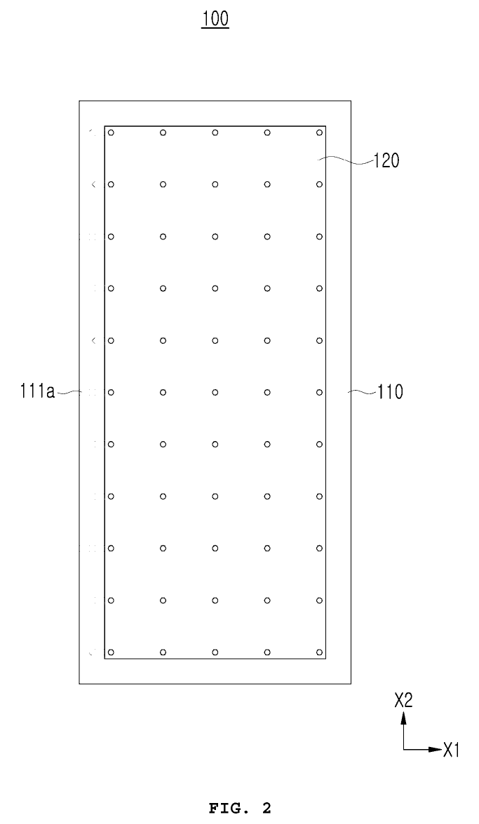

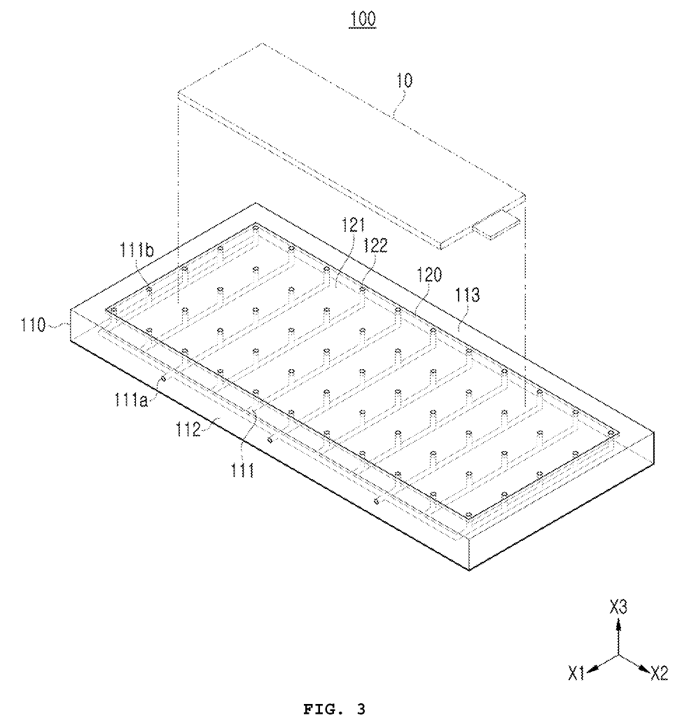

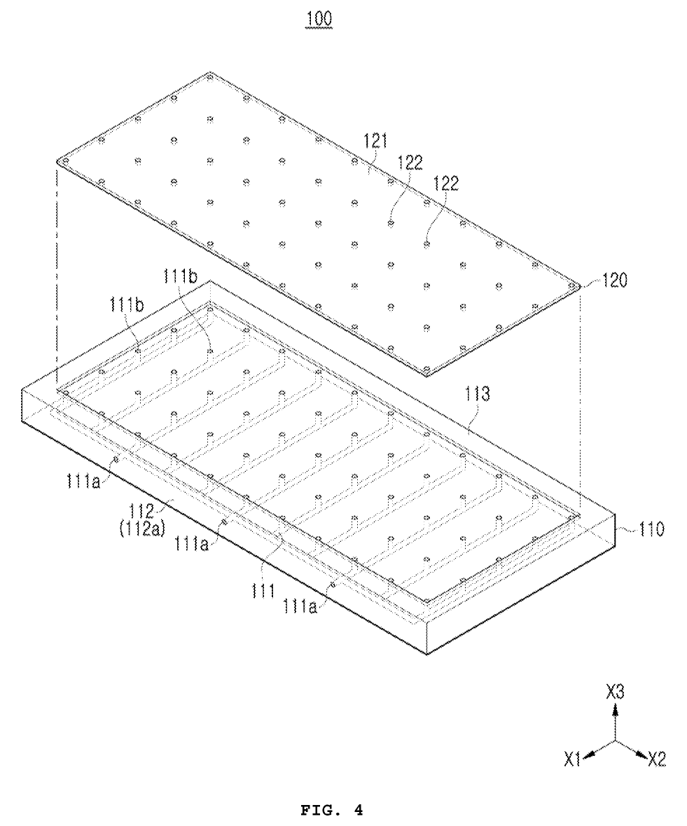

FIG. 2 is a plan view showing an alignment stage according to an embodiment of the present disclosure. FIG. 3 is a perspective view of the alignment stage shown in FIG. 2. FIG. 4 is an exploded perspective view of the alignment stage shown in FIG. 3.

For convenience, hereinafter, based on the coordinate axes shown in FIG. 2, etc., a first direction X1 is referred to as a leftward-rightward direction, a second direction X2 as a forward-backward direction, and a third direction X3 as an upward-downward direction.

Referring to FIGS. 2 to 4, according to an aspect of the present disclosure, an alignment stage 100 may be provided. Here, the alignment stage 100 may include a first plate 110 at least partially made of a first material having light transmittance and a second plate 120 at least partially made of a second material having light transmittance, the second plate being disposed on one surface of the first plate 110, the second plate being provided with a suction surface 121 configured to allow an electrode sheet 10 to be adhered thereto by suction. The second material may have higher hardness than the first material.

More specifically, in some embodiments, the alignment stage 100 may include a first plate 110. In the shown embodiment, the first plate 110 is shown as an approximately cuboid block with a lateral width less than a longitudinal width. However, the specific shape of the first plate 110 may be modified as needed and is not necessarily limited to the illustrated configuration.

In some embodiments, the first plate 110 may be made of a first material having at least partial light transmittance. For example, the first plate 110 may be provided as an integral block made of a first material. In addition, the first material may be a material having light transmittance. In other words, the first material may be a transparent material or a translucent material. In some embodiments, the first material may include acrylic or polycarbonate. A first plate 110 made of acrylic or polycarbonate may have the advantage of a higher degree of freedom in machining than the second plate 120 described later. In other words, a first plate 110 made of acrylic or polycarbonate may contribute to improving machining convenience, reducing cost, etc., in formation of a flow channel 111 described later.

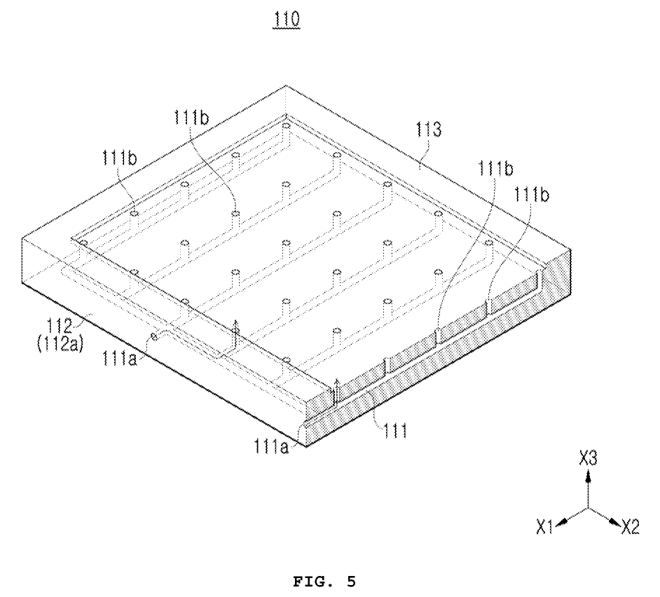

FIG. 5 is a sectional view of the first plate shown in FIG. 4.

Referring to FIG. 5, in some embodiments, the first plate 110 may have a flow channel 111 formed therein. The flow channel 111 may extend in the first plate 110 from a first opening 111a to a second opening 111b.

Here, the first opening 111a may be disposed in an exposed surface 112 of the first plate 110. The exposed surface 112 may refer to an outer surface area of the first plate 110 exposed to the outside. For example, in the shown embodiment, the second plate 120 may be disposed on a part of an upper surface of the first plate 110, and therefore the exposed surface 112 may be the remaining outer surface area of the first plate 110 excluding the part of the upper surface. More specifically, in the shown embodiment, the first plate 110 may be provided with a side surface 112a exposed outward, and the first opening 111a may be disposed in the side surface 112a (i.e., the exposed surface 112).

In addition, the second opening 111b may be provided in one surface of the first plate 110 on which the second plate 120 is disposed. For example, in the shown embodiment, the second plate 120 may be disposed on the upper surface of the first plate 110, and therefore the second opening 111b may be provided so as to correspond to the upper surface.

In addition, the flow channel 111 may extend in the first plate 110 from the first opening 111a to the second opening 111b. Suction pressure for suctioning the electrode sheet 10 may be provided in the flow channel 111. For example, a predetermined suction pressure may be supplied from the outside through the first opening 111a at one end of the flow channel 111, and the supplied suction pressure may be transmitted to the electrode sheet 10 through the second opening 111b at the other end of the flow channel 111. The electrode sheet 10 may be fixed to the alignment stage 100 (i.e., the second plate 120) by suction based on the suction pressure.

In some embodiments, the first opening 111a may be provided in plural. In the shown embodiment, a plurality of first openings 111a is disposed along the side surface 112a of the first plate 110. Furthermore, in some embodiments, the second opening 111b may be provided in plural. The plurality of second openings 111b may be disposed in the upper surface of the first plate 110 with appropriate planar shape, size, etc. considering the shape, size, etc., of the electrode sheet 10 to be machined. In the shown embodiment, the plurality of second openings 111b is disposed at predetermined intervals in the upper surface of the first plate 110 so as to form a rectangular area of a predetermined width.

In some embodiments, the flow channel 111 may extend so as to form a suction pressure transmission path between the plurality of first openings 111a and the plurality of second openings 111b. Furthermore, in some embodiments, the flow channel 111 may be provided in the first plate 110 such that the extension direction thereof is changed at least once. For example, in the shown embodiment, the flow channel 111 may extend rightward from the first opening 111a in a left side surface 112a along the X1 axis, extend upward along the X3 axis, and reach the second opening 111b (see a double-dot dashed line shown on the right side of FIG. 5). Alternatively, in the shown embodiment, the flow channel 111 may extend rightward from the first opening 111a in the left side surface 112a along the X1 axis, extend forward along the X2 axis, extend rightward again along the X1 axis, extend upward along the X3 axis, and reach the second opening 111b (see double-dot dashed line shown in the middle of FIG. 5). The flow channel 111 may be provided in the first plate 110 such that the extension direction thereof is changed at least once in this manner.

In some embodiments, the first plate 110 may be made of a softer material than the second plate 120 described later, and therefore the first plate 110 may facilitate formation of the flow channel 111. For example, the flow channel 111 may be relatively easily formed in the first plate 110 made of acrylic or polycarbonate due to the material properties of the first plate, and therefore the flow channel 111 configured such that the extension direction thereof is changed at least once may be relatively easily formed in the first plate 110. Such a feature may contribute to improving machining convenience, reducing cost, etc., in the manufacture of the alignment stage 100.

Meanwhile, in some embodiments, the first plate 110 may include a protrusion 113. The protrusion 113 may be provided on one surface of the first plate 110 on which the second plate 120 is disposed. For example, in the shown embodiment, the protrusion 113 may be provided on the upper surface of the first plate 110. The protrusion 113 may be configured to cover at least a part of an edge of the second plate 120. For example, in the shown embodiment, the protrusion 113 may extend so as to cover the entire edge of the second plate 120 (see FIG. 3). More specifically, in the shown embodiment, the second plate 120 is illustrated as having an approximately rectangular shape, and the protrusion 113 extends in the shape of a rectangular frame that wraps around an outer edge of the rectangular second plate. In other words, a rectangular recess corresponding to the second plate 120 may be formed in the upper surface of the first plate 110, and a relatively protruding protrusion 113 may be formed on the edge of the upper surface of the first plate 110 by the recess.

The protrusion 113 may cover the edge of the second plate 120 to prevent damage to the edge of the second plate 120. In some embodiments, the second plate 120 may be made of a more fragile material (i.e., a more brittle material) than the first plate 110, and the edge of the second plate 120 made of the brittle material may be covered by the protrusion 113, whereby damage to the edge may be appropriately prevented. Furthermore, in some embodiments, the protrusion 113 may function to guide the appropriate coupling position of the second plate 120 on one surface of the first plate 110.

In some embodiments, the height of the protrusion 113 may correspond to the thickness of the second plate 120. The protrusion 113 enables an upper surface of the alignment stage 100, with the first and second plates 110 and 120 coupled, to have a uniform height.

Referring back to FIGS. 2 to 4, in some embodiments, the alignment stage 100 may include a second plate 120. In the shown embodiment, the second plate 120 is illustrated as a cuboid panel having a size slightly less than the size of the upper surface of the first plate 110. However, the specific shape of the second plate 120 may be modified as needed and is not necessarily limited to the illustrated configuration.

In some embodiments, the second plate 120 may be made of a second material having at least partial light transmittance. For example, the second plate 120 may be formed in the shape of an integral panel made of a second material. Here, the second material may have higher hardness than the first material. In other words, the second plate 120 may be made of a material having higher hardness than the material of the first plate 110. Meanwhile, similar to the first material, the second material may be a material having light transmittance. In other words, the second material may be a transparent or translucent material. In some embodiments, the second material may include glass or soda-lime glass. Glass or soda-lime glass may have light transmittance and higher hardness than the first material, such as acrylic or polycarbonate.

The second plate 120 may have a suction surface 121 to which the electrode sheet 10 adheres by suction. In the shown embodiment, the suction surface 121 corresponds to the upper surface of the second plate 120. A plurality of electrode sheets 10 may be repeatedly attached to and detached from the suction surface 121, and the second plate 120, which is made of a relatively hard material, may contribute to ensuring that the alignment stage 100 can withstand such repeated processes. In other words, the second plate 120, which is in direct contact with the electrode sheet 10, is partially made of a hard material, and therefore the alignment stage 100 may have appropriate durability to withstand repeated placement of the electrode sheet 10 thereon.

In addition, the second plate 120 may contribute to improving the light transmittance of the alignment stage 100. In other words, the second plate 120 may be made of a relatively hard material, such as glass or soda lime, whereby it is possible to contribute to maintaining appropriate light transmittance during use despite repeated placement of the electrode sheet 10. Accordingly, the camera disposed under the alignment stage 100 may acquire a clearer image of the electrode sheet 10 or acquire an appropriate image of the electrode sheet 10 for a longer period without replacement of the alignment stage 100.

Furthermore, in some embodiments, the second plate 120 made of glass or soda-lime glass may function to prevent yellowing of the alignment stage 100 due to ultraviolet light. Furthermore, in some embodiments, the second plate 120 may have a predetermined thickness so as to ensure appropriate strength. For example, the second plate 120 may have a thickness of 0.5 t or more, 0.7 t or more, or 1 t or more.

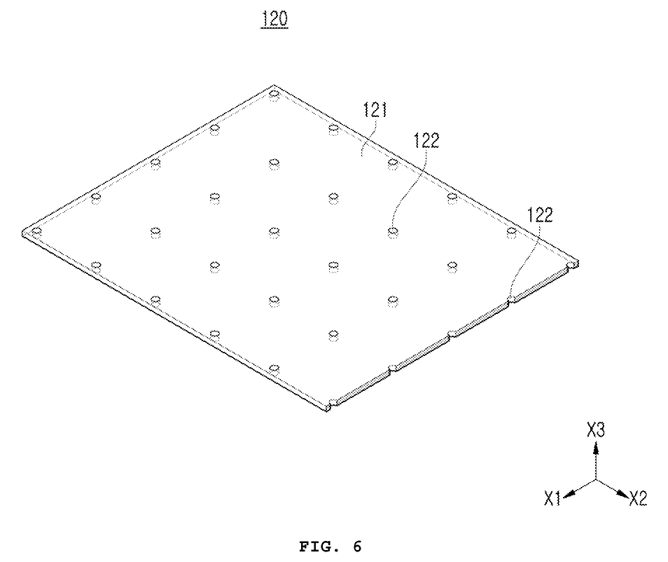

FIG. 6 is a sectional view of the second plate shown in FIG. 4.

Referring to FIG. 6, in some embodiments, the second plate 120 may have at least one through-hole 122. The through-hole 122 may be formed through the second plate 120 in a thickness direction from the suction surface 121. For example, in the shown embodiment, the through-hole 122 may be formed through the second plate 120 from the upper surface of the second plate 120 in the upward-downward direction.

Here, the second plate 120 may be formed in the shape of a panel having a predetermined thickness, and the through-hole 122 may be formed through the second plate 120 in one direction. In other words, unlike the flow channel 111 of the first plate 110, the through-hole 122 may be provided as a single hole extending in one direction, e.g., in the thickness direction of the second plate 120. The through-hole 122 may facilitate formation of the through-hole 122 in the second plate 120 made of the relatively hard material. In other words, the through-hole 122 may be provided as a single hole extending in the thickness direction of the second plate 120, whereby the through-hole 122 may be easily formed in the second plate 120 even though the second plate 120 is made of a hard material. For example, the through-hole 122 may be relatively easily formed even in a material such as glass or soda-lime glass. As the result of combination of the first and second plates 110 and 120 made of different materials, durability and light transmittance of the alignment stage 100 may be improved while machining convenience, cost, etc. of the alignment stage are maintained at appropriate levels.

Meanwhile, in some embodiments, the through-hole 122 may be provided in plural, and the plurality of through-holes 122 may be disposed on the suction surface 121 so as to be spaced apart from each other by a predetermined distance. In addition, each through-hole 122 may be disposed so as to correspond to the second opening 111b. Accordingly, a predetermined suction pressure may be provided to each through-hole 122 through the flow channel 111, and the electrode sheet 10 may be appropriately fixed to the suction surface 121 by suction based on the suction pressure. For reference, in the shown embodiment, the plurality of through-holes 122 is illustrated as being disposed on the upper surface of the second plate 120 at predetermined intervals while forming a predetermined rectangular area corresponding to the plurality of second openings 111b. However, the arrangement of the through-holes 122 or the second openings 111b may be varied as needed and is not necessarily limited to the illustrated configuration.

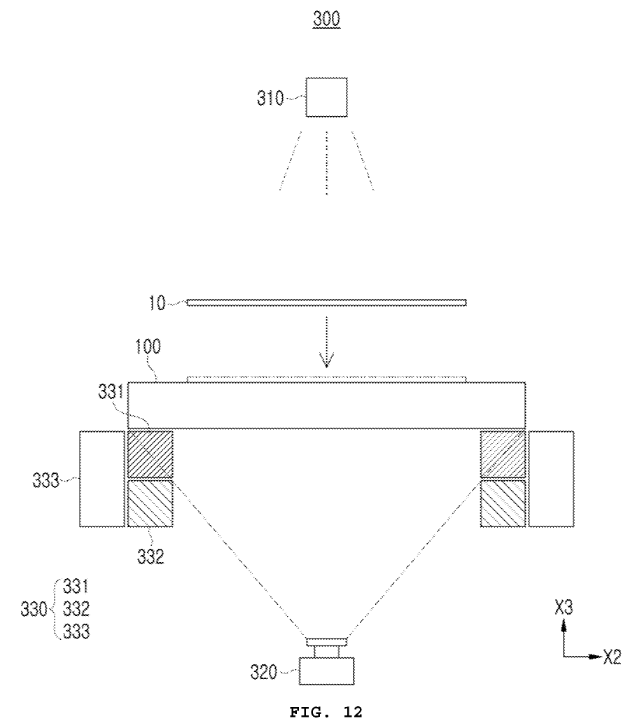

The operation of the alignment stage 100 will be described later with reference to FIG. 12, etc.

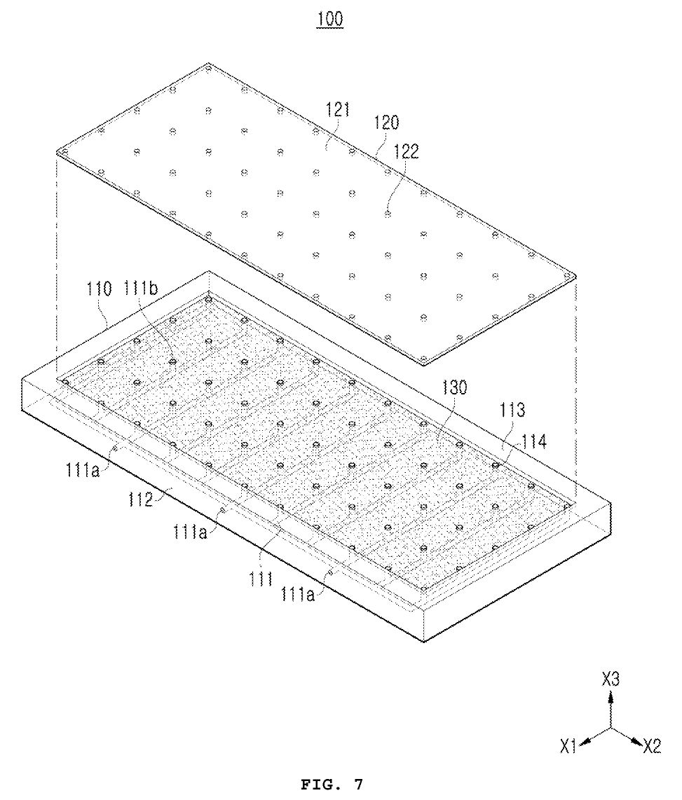

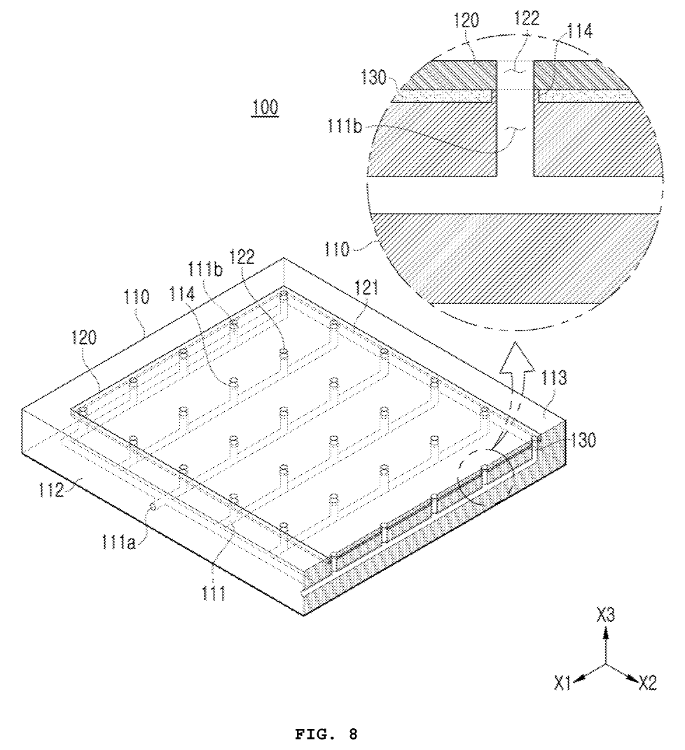

FIG. 7 is an exploded perspective view showing an alignment stage according to another embodiment of the present disclosure. FIG. 8 is a sectional view of the alignment stage shown in FIG. 7.

For convenience, the following description will focus on the differences from the previous embodiment.

Referring to FIGS. 7 and 8, in some embodiments, the second plate 120 may be adhered to the first plate 110. For example, in the shown embodiment, the second plate 120 may be seated on the upper surface of the first plate 110, and an adhesive layer 130 may be provided between the first and second plates 110 and 120. The adhesive layer 130 may be configured to fix the first and second plates 110 and 120 to each other by adhesion. In some embodiments, the adhesive layer 130 may be made of an adhesive having light transmittance. For example, the adhesive layer 130 may made of an epoxy adhesive, acrylic adhesive, silicone adhesive, or UV-curable adhesive having transparent or translucent properties.

Meanwhile, in some embodiments, the first plate 110 may be provided with a sleeve 114. The sleeve 114 may extend along the edge of the second opening 111b. More specifically, the second opening 111bmay be disposed on the upper surface of the first plate 110 as described above, and the sleeve 114 may be formed along the edge of the second opening 111b. The sleeve 114 may be formed in the shape of a closed figure extending along the edge of the second opening 111b so as to have the second opening 111b therein when viewed in the plane. For example, in the shown embodiment, the sleeve 114 may extend along the edge of the second opening 111b in a circular shape. Furthermore, the sleeve 114 may have a predetermined height from the upper surface of the first plate 110. For example, in the shown embodiment, the sleeve 114 protrudes from the upper surface of the first plate 110 by a predetermined height so as to correspond approximately to the height of the adhesive layer 130.

The sleeve 114 may function to prevent the adhesive layer 130 from flowing into the second opening 111b during the assembly process of the alignment stage 100. Specifically, during the assembly process of the alignment stage 100, when the first plate 110 is prepared and an adhesive is applied to the upper surface of the first plate 110, the sleeve 114 may function to restrict the flow of the applied adhesive into the second opening 111b. In addition, the second plate 120 may be appropriately adhered to the upper surface of the first plate 110 in this state. Accordingly, assembly defects, such as the adhesive or the adhesive layer 130 flowing into the second opening 111b and blocking the second opening 111b, may be appropriately prevented during the assembly process.

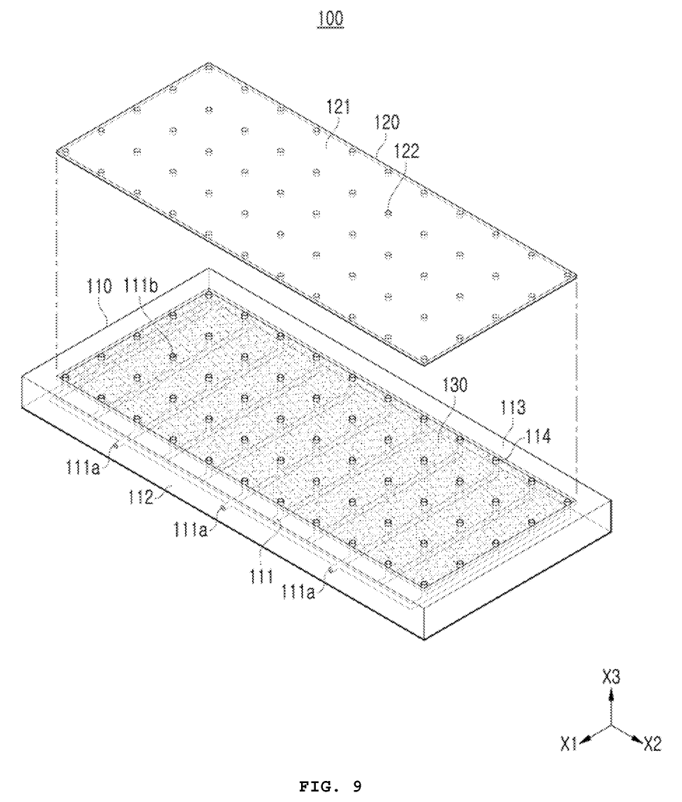

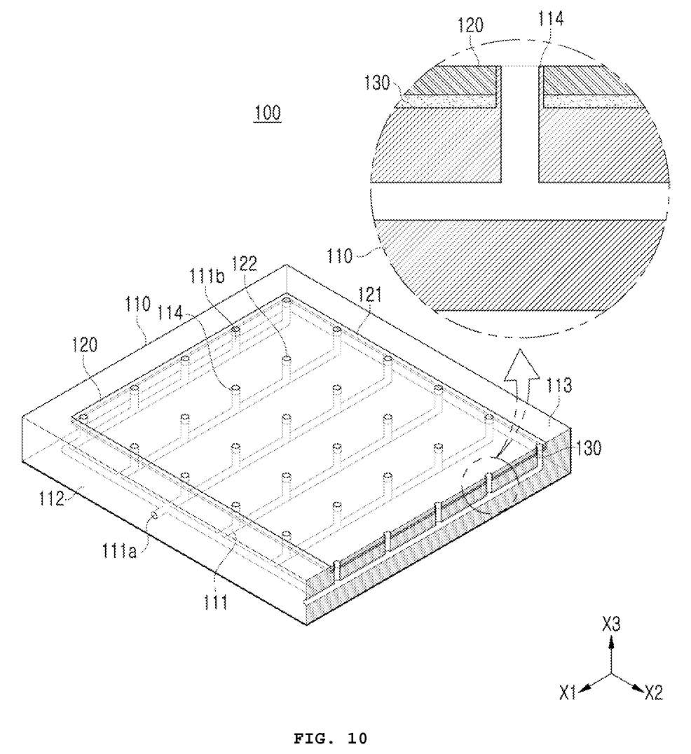

FIG. 9 is an exploded perspective view showing an alignment stage according to yet another embodiment of the present disclosure. FIG. 10 is a sectional view of the alignment stage shown in FIG. 9.

Referring to FIGS. 9 and 10, in some embodiments, the sleeve 114 may protrude from than the upper surface of the first plate 110 to a higher position. For example, as shown, the sleeve 114 may extend from the upper surface of the first plate 110 to the upper surface (i.e., the suction surface 121) of the second plate 120. An upper end of the sleeve 114 may be inserted into and fastened to the through-hole 122 provided in the second plate 120 to assist coupling between the first and second plates 110 and 120. In addition, the sleeve 114 may function to appropriately guide the assembly position of the second plate 120 relative to the first plate 110. However, the upper surface (i.e., the suction surface 121) of the second plate 120 may be formed in a flat shape for appropriate seating of the electrode sheet 10 thereon, and therefore the height of the sleeve 114 may be appropriately set so as not to protrude from the upper surface of the second plate 120.

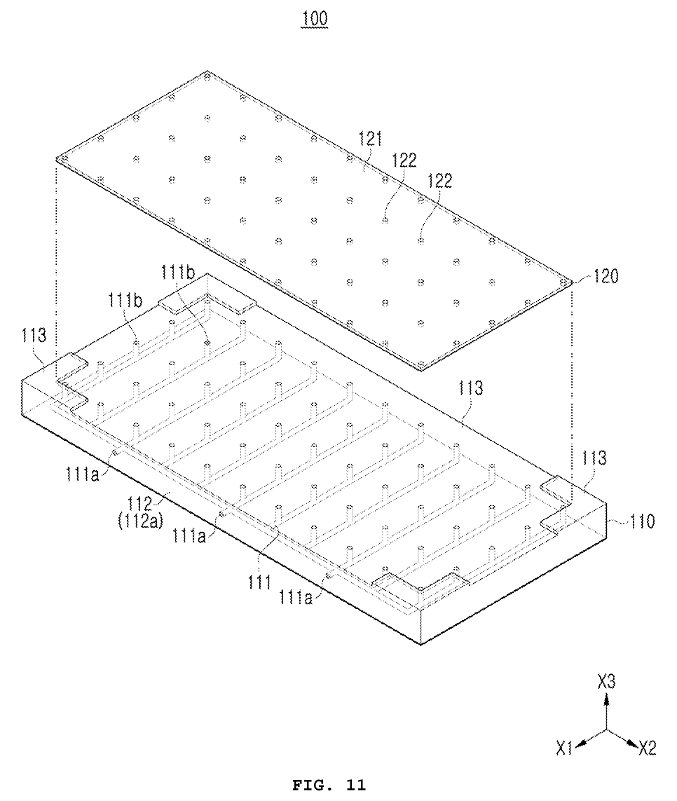

FIG. 11 is an exploded perspective view showing an alignment stage according to a further embodiment of the present disclosure.

Referring to FIG. 11, in some embodiments, the protrusion 113 may be configured to cover a part of the edge of the second plate 120. For example, as shown, the protrusion 113 may be partially provided at the position corresponding to each corner of the second plate 120 so as to cover only the corner. The protrusion 113 may appropriately protect each relatively fragile corner of the second plate 120 while exposing the remaining edge part of the second plate 120, thereby improving assembly between the first and second plates 110 and 120.

FIG. 12 is a side view showing a secondary battery manufacturing apparatus according to an embodiment of the present disclosure.

According to another aspect of the present disclosure, a secondary battery manufacturing apparatus (hereinafter referred to as a “manufacturing apparatus 300”) including the alignment stage 100 may be provided. FIG. 12 shows the main configuration of the manufacturing apparatus 300 based on the alignment stage 100 in a simplified manner.

Referring to FIG. 12, in some embodiments, the manufacturing apparatus 300 may include an alignment stage 100 configured to allow an electrode sheet 10 to be disposed on one surface thereof, an illumination unit 310 disposed on one side of the alignment stage 100 corresponding to the one surface, the illumination unit being configured to illuminate the electrode sheet 10, and a camera 320 disposed on the opposite side of the alignment stage 100 so as to correspond to the illumination unit 310, the camera being configured to capture an image of the electrode sheet 10. The alignment stage 100 may include a first plate 110 made of a first material having at least partial light transmittance and a second plate 120 made of a second material having at least partial light transmittance, the second plate being disposed on one surface of the first plate 110, the second plate being provided with a suction surface 121 configured to allow an electrode sheet 10 to be adhered thereto by suction. The second material may have higher hardness than the first material.

Specifically, in some embodiments, the manufacturing apparatus 300 may include an alignment stage 100. The alignment stage 100 may be configured identically or similarly to those of the aforementioned embodiments.

Meanwhile, in some embodiments, the manufacturing apparatus 300 may include an illumination unit 310. The illumination unit 310 may be disposed on one side of the alignment stage 100 so as to correspond to one surface of the alignment stage 100 on which the electrode sheet 10 is disposed. For example, in the shown embodiment, the electrode sheet 10 may be disposed on an upper surface of the alignment stage 100, and the illumination unit 310 may be disposed above the alignment stage 100. The illumination unit 310 may be disposed above the alignment stage 100 to illuminate the electrode sheet 10 located thereunder.

Meanwhile, although not shown, a transfer apparatus configured to transfer the electrode sheet 10 may be disposed above the alignment stage 100. The transfer apparatus is not particularly limited as long as it is possible to appropriately transfer the electrode sheet 10 and may be constituted by any of various known transfer means.

Meanwhile, in some embodiments, the manufacturing apparatus 300 may include a camera 320. The camera 320 may be disposed on the opposite side of the alignment stage 100 so as to correspond to the illumination unit 310. In other words, in the shown embodiment, the illumination unit 310 may be disposed above the alignment stage 100, and the camera 320 may be disposed under the alignment stage 100 so as to correspond to the illumination unit 310. As described above, the placement of the camera 320 has the advantage of facilitating placement of the transfer apparatus configured to transfer the electrode sheet 10 above the alignment stage 100. The camera 320 is not particularly limited as long as it is possible to appropriately capture an image of the aligned state of the electrode sheet 10 and may be constituted by any of various known image capturing means.

The camera 320 may be disposed under the alignment stage 100, and may capture an image of the electrode sheet 10 disposed on the upper surface of the alignment stage 100. The operation of the camera 320 may be appropriately implemented by the alignment stage 100 having light transmittance. In other words, the alignment stage 100 may be made of first and second materials having light transmittance, allowing an image of the electrode sheet 10 disposed on the upper surface thereof to be properly captured by the camera 320 disposed thereunder. In addition, as described above, the second plate 120 is made of a relatively hard material, such as glass or soda-lime glass, whereby scratches on the second plate 120 caused by the electrode sheet 10 may be prevented. Accordingly, the alignment stage 100 may maintain appropriate light transmittance, and the camera 320 may acquire a clearer image of the electrode sheet 10.

Meanwhile, in some embodiments, the manufacturing apparatus 300 may further include an alignment unit 330. The alignment unit 330 may be configured to correct the position of the alignment stage 100 based on the alignment state of the electrode sheet 10 identified through the camera 320. Accordingly, the position of the electrode sheet 10 adhered to the alignment stage 100 by suction may be appropriately corrected.

In some embodiments, the alignment unit 330 may include a first alignment portion 331 configured to move the alignment stage 100 in the leftward-rightward direction X1 in order to align the lateral position of the alignment stage 100. In addition, the alignment unit 330 may include a second alignment portion 332 configured to move the alignment stage 100 in the forward-backward direction X2 in order to align the longitudinal position of the alignment stage 100. Furthermore, the alignment unit 330 may include a third alignment portion 333 configured to rotate the alignment stage 100 about an axis extending in the upward-downward direction X3 in order to align the rotational (tilting) position of the alignment stage 100. Each of the first to third alignment portions 330 may be implemented by any of various known transfer means, rotation means, etc. In the present disclosure, the operation mode of each of the first to third alignment portions 330 is not particularly limited. For example, each of the first and second alignment portions 331 and 332 may be implemented by a linear transfer means such as an actuator, and the third alignment portion 333 may be implemented by a rotatable support means such as a rotary table. In addition, the alignment unit 330 may be appropriately disposed so as to avoid interference with the illumination unit 310 and the camera 320. For example, the alignment unit 330 may be disposed under the alignment stage 100 so as to correspond to the edge of the alignment stage 100 in order to avoid interfering with illumination of the electrode sheet 10 by the illumination unit 310 and capturing of an image of the electrode sheet 10 by the camera 320.

As described above, some embodiments of the present disclosure may provide an alignment stage and a secondary battery manufacturing apparatus including the same.

In addition, some embodiments of the present disclosure may provide an alignment stage capable of appropriately aligning an electrode sheet and a secondary battery manufacturing apparatus including the same. In some embodiments, the position of the alignment stage is aligned in the state in which the electrode sheet is adhered to the alignment stage by suction, whereby it is possible to appropriately align the electrode sheet prior to stacking of the electrode sheet.

In addition, some embodiments of the present disclosure may provide an alignment stage capable of appropriately capturing an image of the position of an electrode sheet through a camera and a secondary battery manufacturing apparatus including the same. In some embodiments, the alignment stage may have light transmittance, and therefore the camera may appropriately capture an image of the position of the electrode sheet disposed on an upper surface of the alignment stage under the alignment stage.

In addition, some embodiments of the present disclosure may provide an alignment stage capable of more clearly determining the position of an electrode sheet and a secondary battery manufacturing apparatus including the same. In some embodiments, a second plate of the alignment stage configured to allow the electrode sheet to be adhered thereto by suction may be made of a relatively hard material, and therefore a camera disposed under the alignment stage may acquire a clearer image of the electrode sheet. This feature may contribute to more clearly identifying the position of the electrode sheet.

In addition, some embodiments of the present disclosure may provide an alignment stage with improved durability and a secondary battery manufacturing apparatus including the same. In some embodiments, a second plate of the alignment stage configured to allow an electrode sheet to be adhered thereto by suction may be made of a relatively hard material, and therefore light transmittance of the alignment stage may be appropriately maintained despite repeated placement of the electrode sheet. This feature may contribute to increasing the lifespan of the alignment stage, etc.

As is apparent from the above description, some embodiments of the present disclosure may provide an alignment stage and a secondary battery manufacturing apparatus including the same.

In addition, some embodiments of the present disclosure may provide an alignment stage capable of appropriately aligning an electrode sheet and a secondary battery manufacturing apparatus including the same.

In addition, some embodiments of the present disclosure may provide an alignment stage capable of appropriately capturing an image of the position of an electrode sheet through a camera and a secondary battery manufacturing apparatus including the same.

In addition, some embodiments of the present disclosure may provide an alignment stage capable of more clearly determining the position of an electrode sheet and a secondary battery manufacturing apparatus including the same.

In addition, some embodiments of the present disclosure may provide an alignment stage with improved durability and a secondary battery manufacturing apparatus including the same.

The above description is merely an example applying the principles of the present disclosure, and other configurations may be further included without departing from the scope of the present disclosure.

What is claimed is:

1. An alignment stage comprising:
a first plate at least partially made of a first material having light transmittance; and
a second plate at least partially made of a second material having light transmittance, the second plate being disposed on one surface of the first plate, the second plate being provided with a suction surface configured to allow an electrode sheet to be adhered thereto by suction, wherein
the second material has higher hardness than the first material.

2. The alignment stage according to claim 1, wherein
the first plate is provided with a flow channel in which suction pressure for suctioning the electrode sheet is provided, and
the flow channel extends in the first plate from an at least one first opening disposed in an exposed surface of the first plate to an at least one second opening disposed in the one surface.

3. The alignment stage according to claim 2, wherein the flow channel is provided in the first plate such that an extension direction thereof is changed at least once.

4. The alignment stage according to claim 2, wherein the second opening is disposed so as to correspond to a through-hole provided in the first plate and is configured to supply the suction pressure to the through-hole.

5. The alignment stage according to claim 1, wherein the first plate comprises a protrusion provided on the one surface, the protrusion being configured to cover at least a part of an edge of the second plate.

6. The alignment stage according to claim 5, wherein the protrusion extends so as to cover the entire edge.

7. The alignment stage according to claim 5, wherein the protrusion is configured to guide a coupling position of the second plate on the one surface.

8. The alignment stage according to claim 1, wherein the first material comprises acrylic or polycarbonate.

9. The alignment stage according to claim 1, wherein
the second plate is provided with at least one through-hole, and
the through-hole is formed through the second plate in a thickness direction from the suction surface.

10. The alignment stage according to claim 9, wherein the through-hole is provided in plural so as to be disposed on the suction surface while being spaced apart from each other by a predetermined distance.

11. The alignment stage according to claim 1, wherein the second material comprises glass or soda-lime glass.

12. The alignment stage according to claim 1, further comprising an adhesive layer provided between the first and second plates, the adhesive layer being configured to adhere the first and second plates to each other.

13. The alignment stage according to claim 12, wherein
the first plate has at least one second opening disposed in the one surface thereof, and
a sleeve configured to prevent the adhesive layer from flowing into the second opening is provided at an edge of the second opening.

14. A secondary battery manufacturing apparatus comprising:
an alignment stage configured to allow an electrode sheet to be disposed on one surface thereof;
an illumination unit disposed on one side of the alignment stage corresponding to the one surface, the illumination unit being configured to illuminate the electrode sheet; and
a camera disposed on the opposite side of the alignment stage so as to correspond to the illumination unit, the camera being configured to capture an image of the electrode sheet, wherein
the alignment stage comprises:
a first plate at least partially made of a first material having light transmittance; and
a second plate at least partially made of a second material having light transmittance, the second plate being disposed on one surface of the first plate, the second plate being provided with a suction surface configured to allow the electrode sheet to be adhered thereto by suction, and
the second material has higher hardness than the first material.

15. The secondary battery manufacturing apparatus according to claim 14, further comprising an alignment unit configured to correct a position of the alignment stage based on an alignment state of the electrode sheet identified through the camera.
